(19) United States
(12) Patent Application Publication
(10) Pub. No.: US 2006/0078037 A1
(43) Pub. Date: Apr. 13, 2006

(54) Thermometer with image display

(76) Inventors: Tzong-Sheng Lee, Miao-Li (TW); Long-Der Chen, Hsin-Chu City (TW); Kuo-Hua Tseng, I-Lan (TW); Jia-Shing Wu, Hsin-Chu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/253,675

(22) Filed: Oct. 20, 2005

Related U.S. Application Data
(63) Continuation-in-part of application No. 10/414,088, filed on Apr. 16, 2003, now abandoned.

(51) Int. Cl. G01K 7/00; G01J 5/00

(52) U.S. Cl. 374/170; 374/121

(57) ABSTRACT

A thermometer integrated with an image display includes an infrared radiation sensor and a visible light sensor. The infrared radiation sensor detects the infrared radiation signals that correspond to the human-body temperature, and the visible light sensor captures visible light signals that correspond to a visible figure in a measured portion simultaneously. Accordingly, a user could correctly determine whether the measurement is properly performed by viewing a displayed visible figure.

### CROSS-REFERENCE TO RELATED APPLICATION

This application is a continuation-in-part of U.S. patent application Ser. No. 10/414,088, filed Apr. 16, 2003.

### BACKGROUND OF THE INVENTION

1. Field of the Invention

The present invention concerns a thermometer with image display. Moreover, it is specifically related to a thermometer that uses infrared radiation signals and visible light signals simultaneously to provide the function of diagnosis with visible image.

2. Description of the Prior Art

Because the human-body temperature causes infrared radiation, the human-body temperature can be determined by receiving and analyzing the infrared radiation from the human-body. Especially, the body temperature can be rapidly acquired by using an infrared radiation sensor that detects only a small portion of the human body.

Based on the previous idea, the infrared ear thermometers become popular commercial products. When the sensor of the infrared ear thermometer is placed inside the ear, the inner temperature of the ear can be acquired rapidly. The infrared ear thermometers needs only small amount of signal to obtain the temperature, compared to the mercury thermometer that requires thermal equilibrium between the thermometer and the portion under measured. The ear thermometer is more convenient for measuring the body temperature of children. In general, as shown in FIG. 1A, the conventional infrared ear thermometer has two portions: the infrared radiation detecting means 11 used to detect and sense the infrared radiation signals, and the analyzing and processing means 12 used to analyze and process the infrared radiation signals. Additionally, more complicated infrared ear thermometers have further functions, such as the transmission means 13 (wireless or with wire line), the power source 14, and the controlling interface means 15, as shown in FIG. 1B.

The conventional infrared ear thermometers have been continuously improved to achieve better performance. For example, the ear thermometers are designed to include suitable outline for holding, infrared radiation sensor with higher sensitivity, shorter measuring period, automatic memory function, automatic turn-off function, and less power consumption. However, until now, the conventional ear thermometer still cannot ensure that the body temperature is correctly detected at a proper.

According to the statistical data, about 5 percents of babies have the curved auditory canal. Thus, sometimes the measured temperature is not the needed temperature of ear membrane or the central nerve. Further, even there is no curved auditory canal, owing to the existence of ear wax or the improper operation, the measured temperature is usually the wrong one. Besides, the conventional infrared ear thermometer only can measure temperature but can not provide the feature inside the ear. Hence, even with the infrared radiation sensor having enough sensitivity to measure the temperature in the one cubic-centimeter around the infrared radiation sensor, the conventional infrared ear thermometer can only find whether the ear becomes inflamed, but can not locate the portions that have sickness.

Accordingly, the conventional infrared ear thermometer still is far from being perfect, and then further research and development is necessary.

### SUMMARY OF THE INVENTION

One main purpose of the present invention is to provide a thermometer integrated with an image display. Moreover, the present invention is related to a thermometer that is suitable for measuring the human-body temperature, such the ear, the mouth, and the throat.

Another main purpose of the present invention is to provide a thermometer integrated with an image display for detecting the human-body temperature and acquiring the information(s) from the measured portion of the human-body simultaneously.

A further purpose of the present invention is to provide a thermometer integrated with an image display that can receive and process the infrared radiation signals and the visible light signals simultaneously to overcome the inconvenience of the conventional infrared ear thermometer. The present invention provides a thermometer with an image display which has an infrared radiation sensor and a visible light sensor. Thus, the thermometer with the image display can detect the infrared radiation signals that correspond to the human-body temperature, and the visible light signals that correspond to a visible figure in a measured portion simultaneously. In addition to the human-body temperature that can be acquired, the invention still is capable of deciding whether the accurate measured portion is to be detected and to analyze the condition of the measured portion from the detected visible figure. For example, by using the detected visible figure to decide the measured position of the infrared radiation sensor of the present thermometer, it is possible to decide which measured portion is under detected (especially while the infrared radiation sensor with higher sensitivity). For example, by analyzing the detected visible figure, it is possible to diagnose the measured portion and to diagnose what induces the measured temperature.

To compare with the conventional infrared ear thermometer, the invention has at least the following advantages:

(1) There are two signal types which can be acquired by processing the infrared radiation signals and the visible light signals simultaneously.

Therefore, the disadvantages of conventional thermometer in which only infrared radiation is processed can be prevented.

(2) The location of the infrared radiation sensor can be decided by processing the visible light signals.

Therefore, the risk of measuring temperature of human-body at inaccurate position (such as induced by curved auditory canal or improper operation) can be prevented.

(3) The condition of the measured portion for the human-body can be diagnosed by processing the visible light.

Therefore, the present thermometer can acquire an average temperature of a portion of the human-body by using an infrared radiation sensor with higher sensitivity, and further the distribution of temperature among the measured portion also can be detected.

(4) Both the infrared radiation sensor and the visible light sensor are commercial products and how to separate the infrared radiation and the visible light is the well-known technology.

Therefore, the present thermometer integrated with image display can be implemented by using current commercial products and well-known technology. In other words, the invention only needs a creative and original opinion to do so, the invention confronts low technology difficulty and has low cost.

(5) Both the visible light and the infrared radiation can be detected to form a clear feature (the only limitation is the resolution of the corresponding sensor).

Therefore, the present thermometer is not only a device for measuring temperature distribution, and, moreover, the present thermometer can be used as a compact endoscope.

(6) The transmission technology (both wireless and with wire line) are improved rapidly, and the storage technology also improved.

Therefore, the present thermometer has (or is connected to) a device for recording, transmitting and storing the detected figure. Hence, both temperature and the visible figure can be transmitted into the electronic records, and then the present thermometer is suitable for incorporating the electronic medical history of patients.

### BRIEF DESCRIPTION OF THE DRAWINGS

FIG. 1A to FIG. 1B shows the structures of two conventional infrared ear thermometers;

FIG. 2A to FIG. 2E shows some available structures of the thermometer with image display of the present invention;

FIG. 3A to FIG. 3D shows further available structures of the thermometer with image display of the present invention; and

FIG. 4 shows a detailed block diagram partially illustrating the implementation of the thermometer according to the present invention.

### DESCRIPTION OF THE PREFERRED EMBODIMENT

Some embodiments of the invention are described below. However, notwithstanding the present details, the invention can also be applied in other embodiments. Hence, the scope of the invention is not limited by the following embodiments, but is decided by the present claims.

Initially, the inventors emphasize the essential difference between the conventional infrared ear thermometer and the conventional mercury thermometer is the fact that the infrared ear thermometer only needs to receive some infrared radiation signals from the ambient environment, but the conventional mercury thermometer must wait until the thermal equilibrium with the ambient environment before beginning detecting process. In other words, the infrared ear thermometer significantly only needs to receive the infrared radiation signals and does not react with the ambient environment for achieving the thermal equilibrium. Therefore, any improvement of the infrared ear thermometer can not change the main character mentioned above.

Further, the inventors emphasize that the previous character is based on the fact that the infrared radiation radiates from the human-body, and is proportional to the human-body temperature. Of course, the application of the infrared ear thermometer will not change the temperature of the measured portions, such as the human-body temperature inside ears. However, the inventors particularly emphasize that the character is also suitable for other kinds of electromagnetic radiation, such as the ultraviolet radiation, the microwave or the visible light.

Therefore, the inventors provide a solution to improve the previous disadvantages of the conventional infrared ear thermometer, that is, the infrared radiation and the visible light are detected simultaneously. Herein, both the infrared radiation and the visible light are both the electromagnetic radiation, and then the detection can be finished in a short period without inducing significant variation of the temperature in the measured portions. Indisputably, after the visible light is detected, the information acquired by the present thermometer is not only the human-body temperature indicated by the infrared radiation, but also the visible figure of the measured portion provided from the visible light. Thus, even there are curved auditory canal and/or ear waxes, the probability of improper measurement is clearly decreased. Moreover, by analyzing the visible feature, some information about the condition of the measured portion is further provided (for example, providing which part of the ear becoming inflamed).

Certainly, if the infrared radiation sensor is sensible enough, the acquired information is not only an average human-body temperature among the measured portion of the human-body, but also a visible figure of thermal distribution among the measured portion. Then, further information is provided by the present thermometer.

Of course, the key features of the present thermometer are related to how to acquire the temperature and the image by using both the infrared radiation and the visible light simultaneously. Thus, the main character(s) of the present thermometer is independent on the details of the sensor(s), the device(s) for processing signals and the transmission of the information related to the feature, the human-body temperature, and so on. In other words, the main character(s) of the invention is related to the creative idea that integrates the feature of the visible light to the conventional infrared ear thermometer. Therefore, the invention can use all related prior arts, such as the light sensor and the image processing technology, and then the present invention has no difficult technology problem or increased cost problem.

Besides, because all of the human-body can be visible through the visible light and the infrared radiation, the present thermometer can be used for detecting the human-body temperature other than the ear. The invention can also be used for detecting any portion of the human-body, such as armpit, mouth, nostril, or anus. Surely, in order to avoid the infrared radiation to be interfered by the skin and to bring the visible light into fully play, the invention is very suitable for some portions of the human-body that the thin membrane can be measured directly, such as mouth, nostril, or anus.

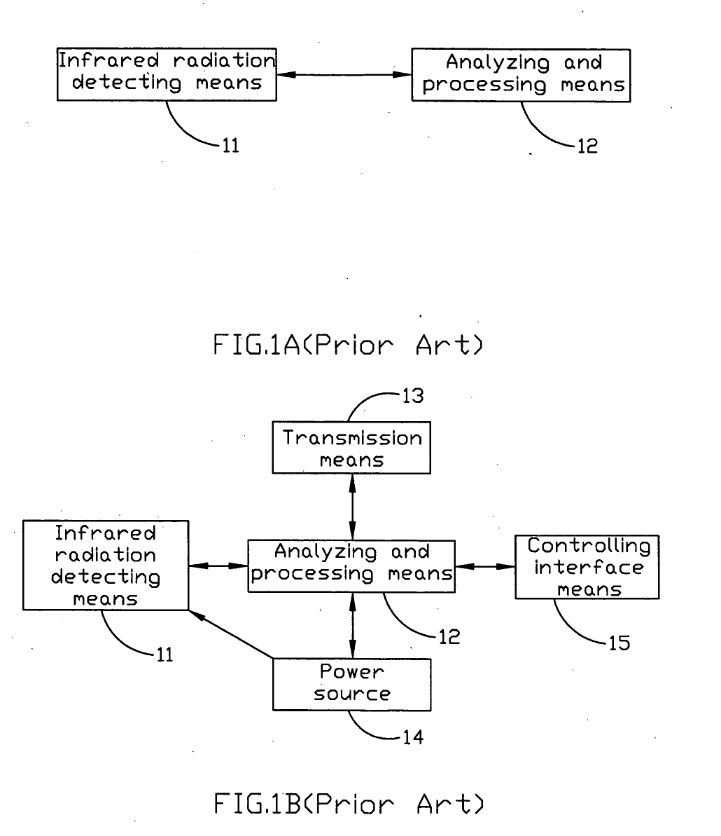

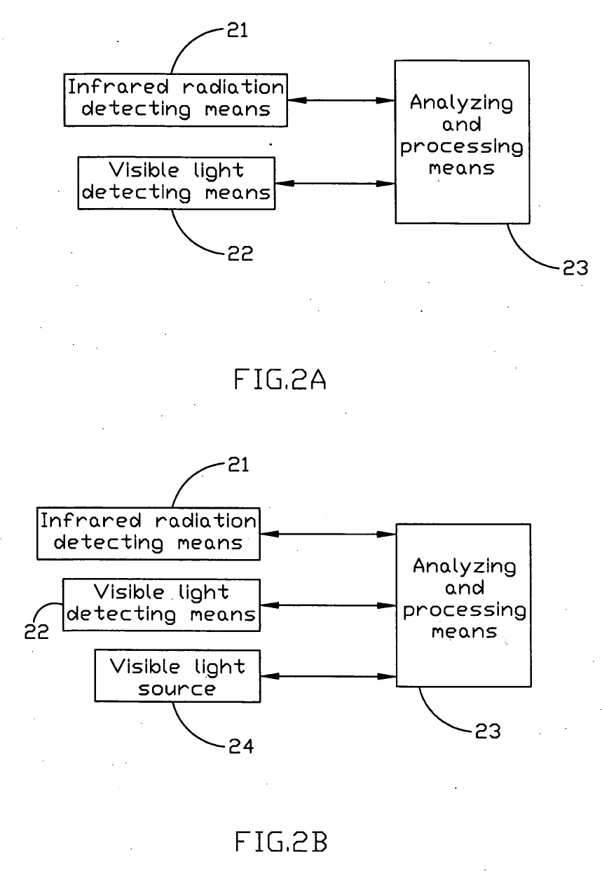

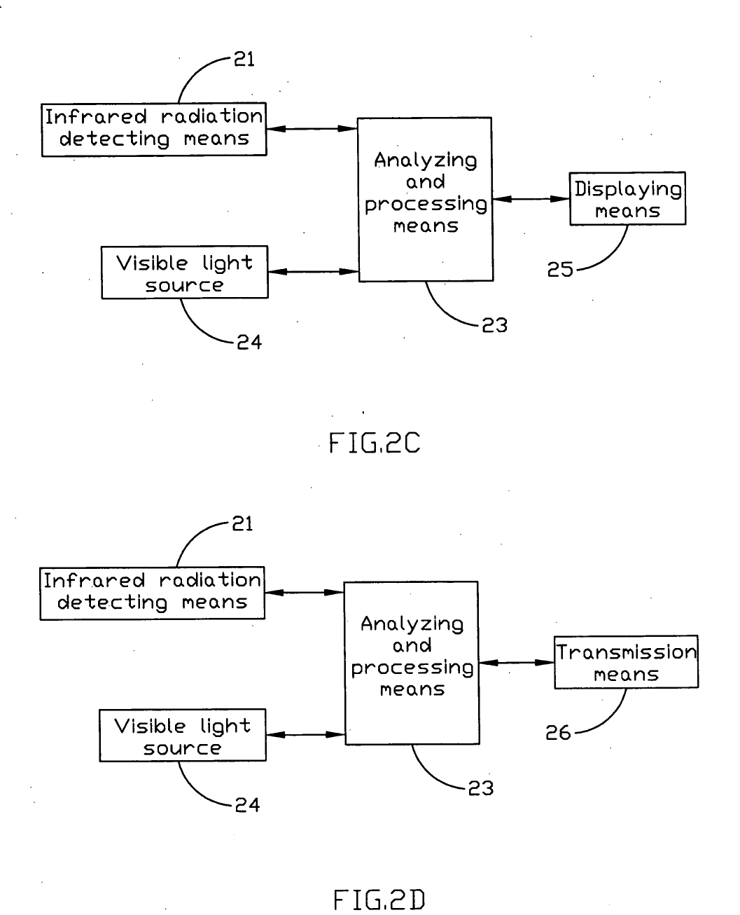

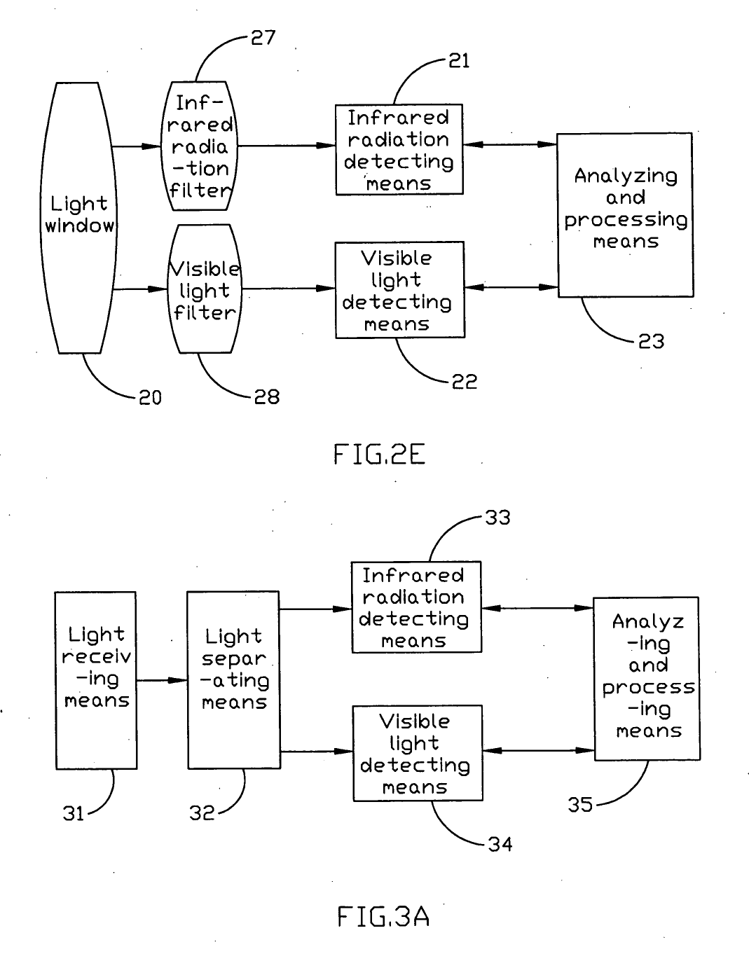

According to the previous discussion, the present invention discloses one preferred embodiment of the thermometer with image display. As shown in FIG. 2A, the present thermometer with image display includes a thermal detecting means 21 such as an infrared radiation detector used to receive and detect infrared radiation signals, the visible image detecting means 22 such as a visible light detector used to receive and detect visible light signals, and the analyzing and processing means 23 used to analyze and process the infrared radiation signals and the visible light signals. Comparing FIG. 2A with FIG. 1A, the main character of the embodiment resides in the visible light detecting means 22. Surely, the requirement of treating the visible light signals is added into the analyzing and processing means 23, which is distinct from the conventional analyzing and processing means 12.

In the embodiment, the visible light signals correspond to and can be used to form a visible figure, and the infrared radiation signals correspond to and can be used to form a thermal distribution if the infrared radiation detecting means 21 is sensible enough.

As shown in FIG. 2B, a visible light source 24 is further included to illuminate the measured portion such as the ear of the human-body. Herein, the visible light source 24 can be, for example, high-efficient light-emitting diode (LED), tungsten-filament bulb, or fluorescent lamps.

As shown in FIG. 2C, the thermometer with image display further includes a displaying means 25. The displaying means 25 is used to show the temperature distribution corresponds to the infrared radiation signals, and shows a detected visible figure corresponds to the visible light signals. As shown in FIG. 2D, the present invention further includes a transmission means 26 that is used to transmit the temperature distribution corresponds to the infrared radiation signals and the whole visible figure corresponds to the visible light signals by way of wireless transmission device or wire-line transmission device.

As shown in FIG. 2E, in order to avoid intermixing the visible light and the infrared radiation, an infrared radiation filter 27 is located between the infrared radiation detecting means 21 and a light window 20, and a visible light filter 28 is located between the visible light detecting means 22 and the light window 20.

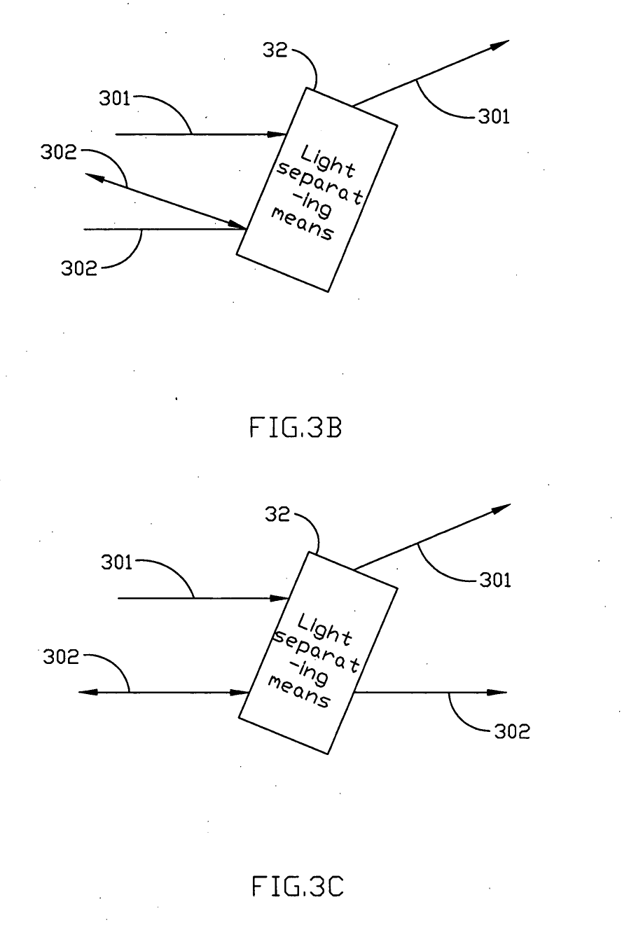

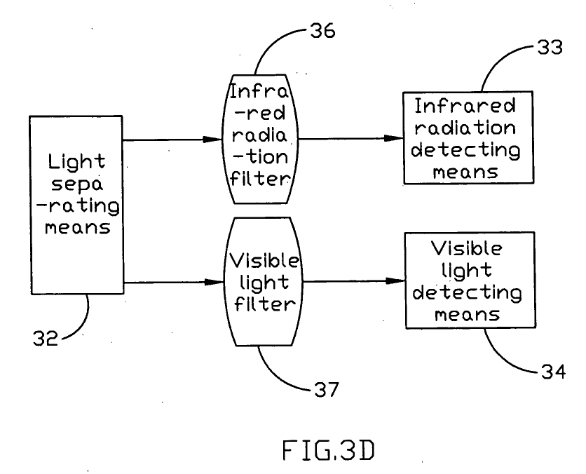

FIG. 3A shows another preferred embodiment of the present invention, where the thermometer with image display includes a light receiving means 31 that receives and detect infrared radiation signals and visible light signals in a measured portion of the human-body. A light separating means 32 is used to separate the infrared radiation signals and the visible light signals from the output of the light receiving means 31, wherein the light separating means 32 can be a germanium window, a silicon window, or a beam splitter. The thermometer with image display also includes an infrared radiation detecting means 33 that is used to detect the infrared radiation signals; a visible light detecting means 34 that is use to detect the visible light signals; and an analyzing and processing means 35 used to analyze and process the infrared signals and the visible light signals. It is noted that, in the embodiment, the infrared radiation detecting means 33 has one dimensional sensor or a single sensor, and the visible light detecting means 34 has a two-dimensional CCD (charge-coupled devices) sensor and/or a CMOS (complementary metal oxide semiconductor) sensor. In this embodiment, the sensor type of the infrared radiation detecting means 33 is different from that of the visible light detecting means 34.

Referring to FIG. 3B, the function of the light separating means 32 passes the infrared radiation signals 301, while the visible light signals 302 are reflected by the light separating means 32. Also referring to FIG. 3C, both the infrared radiation signals 301 and the visible light signals 302 pass through the light separating means 32 with different propagating direction. However, when both the infrared radiation signals 301 and the visible light signals 302 are reflected by the light separating means 32, the propagating direction of the infrared radiation signals 301 is different from the propagating direction of the visible light signals 302.

Referring to FIG. 3D, in order to separate the infrared radiation signals and the visible light signals completely, an infrared radiation filter 36 is located between the light separating means 32 and infrared radiation detecting means 33, and a visible light filter 37 is located between the light separating means 32 and the visible light detecting means 34.

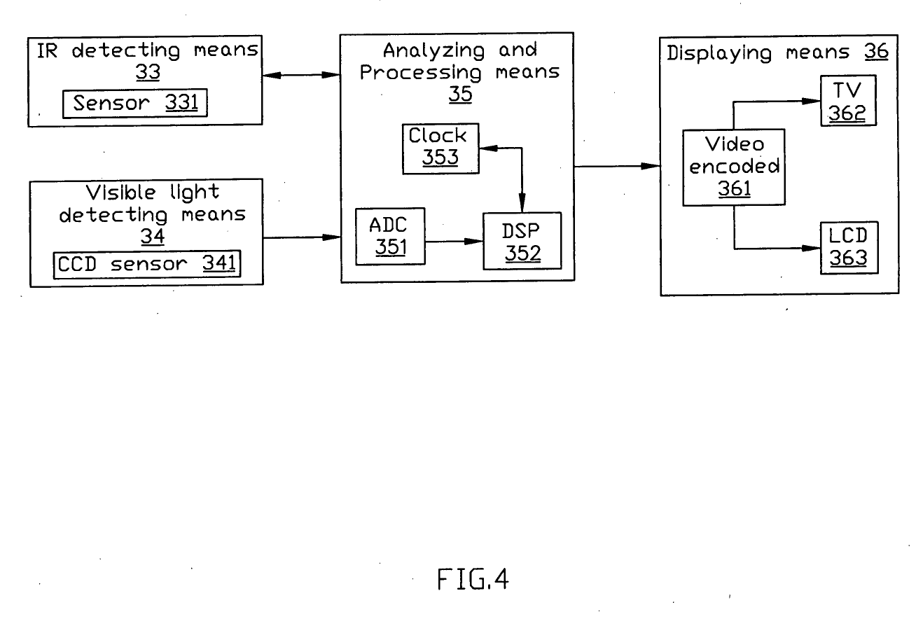

For a better appreciation and understanding of the present invention, a detailed block diagram partially illustrating the implementation of the thermometer according to the present invention is disclosed in FIG. 4. In the present embodiment, the IR detecting means 33 includes a single IR sensor or one-dimensional IR sensors (or line sensors) 331, while the visible light detecting means 34 includes a two-dimensional CCD or CMOS sensors (or array sensor) 341. The IR sensor 331 sequentially detects the amount of the infrared at each point of the measured area, and the detected infrared strength individually corresponds to the measured temperature of each point of the measured area. The collected measured temperatures of all points of the measured area therefore demonstrate the distribution of the detected temperature. On the other hand, the visible light sensors 341 capture the amount of the visible light of the measured area, and the captured visible light then depicts the profile, the contour, or the image of the measured area. Specifically, the IR sensor 331 scans the measured area under the control of a clock generator 353 from the analyzing/processing means 35. The detected IR signals from the IR sensor 331 and the detected visible light signals from the visible light sensors 341 are converted from an analog form into a digital form by an analog-to-digital converter (ADC) 351. The converted IR/visible-light signals are suitable for the analysis/processing of a digital signal processor (DSP) 352, which primarily combines the captured visible-light image and the detected IR signals. The combined image and distribution signals are further encoded in a video encoder 361, such that a suitable signal format is generated and is displayed in a television (TV) 362 or a liquid crystal display (LCD) 363. Accordingly, the measured temperature distribution could be readily and recognizably demonstrated upon the captured visible-light image, so that a viewer could effortlessly identify the abnormal zone by observing the measured temperature distribution, and could also correctly determine whether the measurement is properly performed.

What are discussed above are only the preferred embodiment of the invention and are not used to limit the scope of the invention. Any changes or modifications that do not depart from the essence disclosed by the invention should be limited in what is claimed in the following.

What is claimed is:

1. A thermometer with image display, comprising:
means for illuminating a measured portion;
thermal detecting means for receiving and detecting a plurality of infrared radiation signals and a visible image detecting means for receiving and detecting a plurality of visible light signals from said measured portion simultaneously;
means for analyzing and processing said plurality of infrared radiation signals to obtain the temperature corresponding to the infrared radiation signals and being combined with said plurality of visible light signals corresponding to a visible figure of said measured portion to generate a combined signal; and
means for displaying said combined signal of said measured portion.

2. The thermometer with image display of claim 1, wherein said displaying means further displaying the temperature superimposed on the image, thereby demonstrating a temperature distribution on the image.

3. The thermometer with image display of claim 1, wherein said means for illuminating said measured portion is a visible light source,

4. The thermometer with image display of claim 1, wherein said visible image detecting means includes a sensor that is selected from the group consisting of a charge coupled device sensor (CCD) and a complementary metal oxide semiconductor (CMOS) sensor.

5. The thermometer with image display of claim 1, wherein said thermal detecting means includes one dimensional CCD sensor or a single CCD sensor.

6. A thermometer with image display, comprising:
means for illuminating a measured portion;
means for receiving a plurality of infrared radiation signals and a plurality of visible light signals from said measured portion simultaneously;
means for separating said plurality of infrared radiation signals and said plurality of visible light signals;
a thermal detecting means for receiving and detecting a plurality of infrared radiation signals and an image visible detecting means for receiving and detecting a plurality of visible light signals in said measured portion simultaneously;
means for analyzing and processing said plurality of infrared radiation signals and said plurality of visible light signals simultaneously to be a combined signal;
means for transmitting said combined signal of said measured portion; and
means for displaying said combined signal of said measured portion.

7. The thermometer with image display of claim 6, wherein said displaying means further displaying the temperature superimposed on the image, thereby demonstrating a temperature distribution on the image.

8. The thermometer with image display of claim 6, wherein said means for illuminating a measured portion is a visible light source.

9. The thermometer with image display of claim 6, wherein said visible image detecting means includes a sensor that is selected from the group consisting of a charge coupled device sensor (CCD) and a complementary metal oxide semiconductor (CMOS) sensor.

10. The thermometer with image display of claim 6, wherein said thermal detecting means includes one dimensional CCD sensor or a single CCD sensor.

11. The thermometer with image display of claim 6, wherein said means for separating said plurality of infrared radiation signals and said plurality of visible light signals is selected from the group consisting of a germanium windows, and a silicon windows.

12. The thermometer with image display of claim 6, wherein said transmitting means is selected from the group consisting of a wireless transmission device and a wire-line transmission device.

13. The thermometer with image display of claim 6, wherein a propagating direction is different between said plurality of infrared radiation signals and said plurality of visible light signals after both said plurality of infrared radiation signals and said plurality of visible light signals passed through said means for separating said plurality of infrared radiation signals and said plurality of visible light signals.

14. The thermometer with image display of claim 6, wherein a propagating direction is different between said plurality of infrared radiation signals and said plurality of visible light signals after both said plurality of infrared radiation signals and said plurality of visible light signals are reflected by said means for separating said plurality of infrared radiation signals and said plurality of visible light signals.

15. A thermometer with image display, comprising:
means for illuminating a measured portion of a human body;
thermal means for detecting and receiving a plurality of infrared radiation signals and a visible figure means for detecting and receiving a plurality of visible light signals simultaneously in said measured portion;
means for scanning said plurality of infrared radiation signals corresponding to a temperature value at each point in said measured portion;
means for combining said temperature value at said each point with said plurality of visible light signals to generate a combined signal;
means for encoding said combined signal to transform into an output image signal; and
means for displaying said output image signal that includes a temperature distribution corresponding to said temperature value at said each point and a whole visible image corresponding to said plurality of visible light signals in said measured portion.

16. The thermometer with image display of claim 15, wherein said means for illuminating said measured portion of said human body is a visible light source.

17. The thermometer with image display of claim 15, wherein said thermal detecting means includes one dimensional CCD sensor or a single CCD sensor.

18. The thermometer with image display of claim 15, wherein said visible image detecting means includes a sensor that is selected from the group consisting of a charge coupled device sensor (CCD) and a complementary metal oxide semiconductor (CMOS) sensor.
